(19) United States
(12) Patent Application Publication
(10) Pub. No.: US 2026/0299619 A1
(43) Pub. Date: Oct. 1, 2026

(54) Systems and Methods for Facilitating Communication of Semantic Data Between a Fleet of Agents

(71) Applicant: ROCKWELL AUTOMATION CANADA LTD., Cambridge (CA)

(72) Inventors: Krispin Alexander DAVIES, Kitchener (CA); Enrique FERNÁNDEZ PERDOMO, Girona (ES); Syeda Mariam AHMED, Waterloo (CA); Ivor WANDERS, Kitchener (CA); Nolan LUNSCHER, Kitchener (CA); Jason MERCER, Kitchener (CA); Marco PICCINELLI, Kitchener (CA); Omar Serag Mohamed Serag ELMOFTY, Cambridge (CA); Guillaume Michel AUTRAN, Waterloo (CA); Robert BRADFORD, Ajax (CA); Mohammad Ahmad MUNAWAR, Waterloo (CA)

(21) Appl. No.: 19/095,923

(22) Filed: Mar. 31, 2025

(51) Int. Cl. G05D 1/69; G05D 1/226; G05D 107/70

(52) U.S. Cl. CPC G05D 1/69; G05D 1/226; G05D 2107/70

(57) ABSTRACT

Systems and methods for facilitating communication of semantic data between a fleet of agents is provided. The method includes: receiving, at a first agent of the fleet, sensor data using one or more sensors in communication with the first agent; applying one or more artificial intelligence (AI) models to the sensor data, the one or more AI models being trained to generate the semantic data; evaluating the semantic data to determine whether the semantic data is relevant to one or more other agents of the fleet; responsive to determining that the semantic data is relevant to a second agent of the fleet, initiating the first agent to communicate the semantic data to the second agent; and in response to receiving the semantic data, operating a semantic interpretation system at the second agent to analyze the semantic data to determine one or more operations at the second agent.

### TECHNICAL FIELD

The described embodiments relate to systems and methods for facilitating communication, and in particular, to systems and methods for facilitating communication of semantic data between a fleet of agents.

### BACKGROUND

The following paragraphs are not an admission that anything discussed in them is prior art or part of the knowledge of persons skilled in the art.

The introduction of automated and autonomous systems in the performance of industrial and manufacturing processes has the potential to provide overall increases in productivity and utility. As automated and autonomous systems become more complex and include more subsystems, components, and software, there is an associated increase in the amount of data that is generated by these systems.

An industrial or manufacturing environment may include many automated and/or autonomous systems. The data generated by any one system may be usable by other systems within the environment. However, data communication in many environments can be constrained by various factors, such as infrastructure limitations, communication-related overhead (e.g., memory, bandwidth, or other resources), and data transfer latency. Effective communication between the multiple automated and/or autonomous systems is needed to enable improvement in productivity and/or utility.

### SUMMARY

In a first aspect, there is a method for facilitating communication of semantic data between a fleet of agents comprising one or more autonomous mobile robots, each autonomous mobile robot having a processor. The method includes: receiving, at a first agent of the fleet, sensor data using one or more sensors in communication with the first agent; applying one or more artificial intelligence (AI) models to the sensor data, the one or more AI models being trained to generate the semantic data for the fleet of agents from at least the sensor data; evaluating the semantic data to determine whether the semantic data is relevant to one or more other agents of the fleet; responsive to determining that the semantic data is relevant to a second agent of the fleet, initiating the first agent to communicate the semantic data to the second agent; and in response to receiving the semantic data, operating a semantic interpretation system at the second agent to analyze the semantic data to determine one or more operations at the second agent.

According to some embodiments, evaluating the semantic data to determine whether the semantic data is relevant includes determining that the generated semantic data is new compared with stored semantic data; and determining that the generated semantic data is usable in performing an operation at the one or more other agents.

According to some embodiments, the one or more AI models are trained to map the sensor data to a multi-dimensional vector space to compress data size of the generated semantic data compared with the sensor data.

According to some embodiments, the one or more AI models include one or more of a large language model, a vision language model and an audio language model.

According to some embodiments, the semantic data includes data generated using natural language processing of a user input.

According to some embodiments, the first agent is an autonomous mobile robot that receives the sensor data while autonomously executing a mission at an industrial facility.

According to some embodiments, the generated semantic data is communicated by the first agent to the second agent via a fleet manager.

According to some embodiments, the fleet manager aggregates semantic data received from multiple agents.

According to some embodiments, the fleet manager aggregates the semantic data based on location and/or timing information associated with the semantic data.

According to some embodiments, the semantic interpretation system at the second agent is operated to determine one or more operations of a perception system, a control system and/or a safety system of the second agent based at least in part on the semantic data received from the first agent.

In a second aspect, there is a system for facilitating communication of semantic data. The system includes a communication network; and a fleet of agents comprising one or more autonomous mobile robots. The fleet of agents is operable to communicate with each other via the communication network, each agent of the fleet having a processor. The processors are collectively operable to: receive, at a first agent of the fleet, sensor data from one or more sensors in communication with the first agent; apply one or more artificial intelligence (AI) models to the sensor data, the one or more AI models being trained to generate the semantic data for the fleet of agents from at least the sensor data; evaluate the semantic data to determine whether the semantic data is relevant to one or more other agents of the fleet; responsive to determining that the semantic data is relevant to a second agent of the fleet, initiate the first agent to communicate the semantic data to the second agent; and in response to receiving the semantic data, operate a semantic interpretation system at the second agent to analyze the semantic data to determine one or more operations at the second agent.

According to some embodiments, evaluation of the semantic data to determine whether the semantic data is relevant includes determining that the generated semantic data is new compared with stored semantic data; and determining that the generated semantic data is usable in performing an operation at the one or more other agents.

According to some embodiments, the one or more AI models are trained to map the sensor data to a multi-dimensional vector space to compress data size of the generated semantic data compared with the sensor data.

According to some embodiments, the one or more AI models include one or more of a large language model, a vision language model and an audio language model.

According to some embodiments, the semantic data includes data generated using natural language processing of a user input.

According to some embodiments, the first agent is an autonomous mobile robot that receives the sensor data while autonomously executing a mission at an industrial facility.

According to some embodiments, the generated semantic data is communicated by the first agent to the second agent via a fleet manager.

According to some embodiments, the fleet manager aggregates semantic data received from multiple agents.

According to some embodiments, the fleet manager aggregates the semantic data based on location and/or timing information associated with the semantic data.

According to some embodiments, the semantic interpretation system at the second agent is operated to determine one or more operations of a perception system, a control system and/or a safety system of the second agent based at least in part on the semantic data received from the first agent.

### BRIEF DESCRIPTION OF THE DRAWINGS

Several embodiments will now be described in detail with reference to the drawings, in which:

FIG. 1 is a block diagram of a system for facilitating communication of semantic data between a fleet of agents, according to at least one embodiment;

FIG. 2A is a block diagram of an example embodiment of an agent of the fleet of FIG. 1;

FIG. 2B is a block diagram of another example embodiment of an agent of the fleet of FIG. 1;

FIG. 2C is a block diagram of another example embodiment of an agent of the fleet of FIG. 1;

FIG. 2D is a block diagram of another example embodiment of an agent of the fleet of FIG. 1;

FIG. 3 is a schematic diagram illustrating an example embodiment in which the agent of FIG. 2A is a self-driving industrial vehicle;

FIG. 4 is a flow diagram of a method for facilitating communication of semantic data between a fleet of agents, according to at least one embodiment;

FIG. 5 is a schematic diagram illustrating an exemplary implementation of the method of FIG. 4;

FIG. 6 is a schematic diagram illustrating another exemplary implementation of the method of FIG. 4;

FIG. 7 is a schematic diagram illustrating another exemplary implementation of the method of FIG. 4;

FIG. 8 is a schematic diagram illustrating another exemplary implementation of the method of FIG. 4; and

FIG. 9 is a schematic diagram illustrating another exemplary implementation of the method of FIG. 4.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112a, 112b, and 112c). All elements with a common base number may be referred to collectively or generically using the base number without a suffix (e.g., 112).

### DETAILED DESCRIPTION

The disclosed systems and methods can facilitate communication of semantic data between a fleet of agents. The semantic data may include any logical information generated based on input data. An agent may include any device or software module that can generate, communicate and/or utilize semantic data.

The semantic data generated at an agent may be utilized to control one or more operations of the agent. For example, an autonomous mobile robot (AMR) may receive input image data of its environment from a camera. The AMR may generate semantic data indicating type and position of objects in its environment (e.g., people, forklifts, road lanes, signs, etc.) based on the input image data. Further, the AMR may determine its navigation operations based on the generated semantic data.

The disclosed systems and methods can facilitate communication of the semantic data generated at an agent to other agents in the fleet. The other agents may utilize the received semantic data to determine one or more of their operations. The disclosed systems and methods can provide improved fleet performance and/or utility by facilitating communication of semantic data between a fleet of agents. For example, an AMR may use input image data to generate semantic data indicating that a misplaced pallet is blocking a travel path. The AMR can communicate the generated semantic data to other agents on the fleet. In response to receiving the semantic data, other AMRs may update their navigation operations to avoid the blocked path. Further, in response to receiving the semantic data, a fleet manager may dispatch a forklift to move the misplaced pallet.

The semantic data may have a smaller data size compared with the input data. With reference to the above-described example, the semantic data indicating a misplaced pallet at a specified location may have a smaller data size compared with the input image(s) showing the pallet. By facilitating communication of the semantic data, the disclosed systems and methods can provide an improvement in functioning of computer systems. The smaller data size of the semantic data can reduce memory usage at one or more agents of the fleet. The smaller data size of the semantic data can further reduce network bandwidth requirements for data communication between the fleet of agents. Further, because the input data is already processed to generate the semantic data, the disclosed systems and methods may improve processing speed at agents that can utilize the received semantic data to determine one or more of their operations.

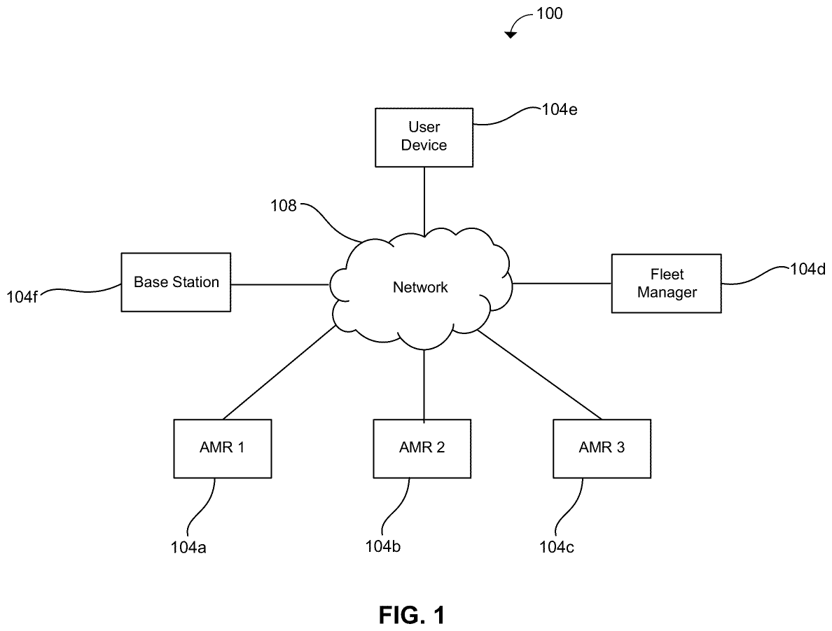

Referring now to FIG. 1, there is shown a block diagram of a system 100 for facilitating communication of semantic data between a fleet of agents 104, according to at least one embodiment. The fleet may include any suitable number of agents. In the illustrated example, the fleet includes six agents. In other examples, the fleet may include a different number of agents (for example, 2 to 5 or greater than 6 agents).

The agents 104 can be communicatively coupled using a network 108. Network 108 may include any suitable communication network or network components usable by agents 104 to communicate with each other. Network 108 may include, for example, the Internet, Ethernet, fiber optics, satellite, mobile, wireless (e.g., Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

In the illustrated example, agents 104a-104f are communicatively coupled using a single network 108. In other examples, agents 104a-104f may be communicatively coupled using a combination of multiple networks.

In some embodiments, the fleet may include different types of agents 104. For example, an agent may be mobile (e.g., a robot, a drone, a vehicle, etc.) or fixed in position (e.g., a charging station, a wall-mounted camera, etc.). As another example, an agent may be non-autonomous, semi-autonomous or fully autonomous. In the illustrated example, the fleet includes AMRs 104a-104c, a fleet manager 104d, a user device 104e and a base station 104f. The different types of agents may provide different functionalities. For example, AMRs 104a-104c may generate, communicate, and utilize semantic data. As another example, base station 104f may not generate or utilize semantic data but may enable communication of semantic data between other agents. In some embodiments, all the agents of the fleet may be of the same type (for example, the fleet may only include AMRs).

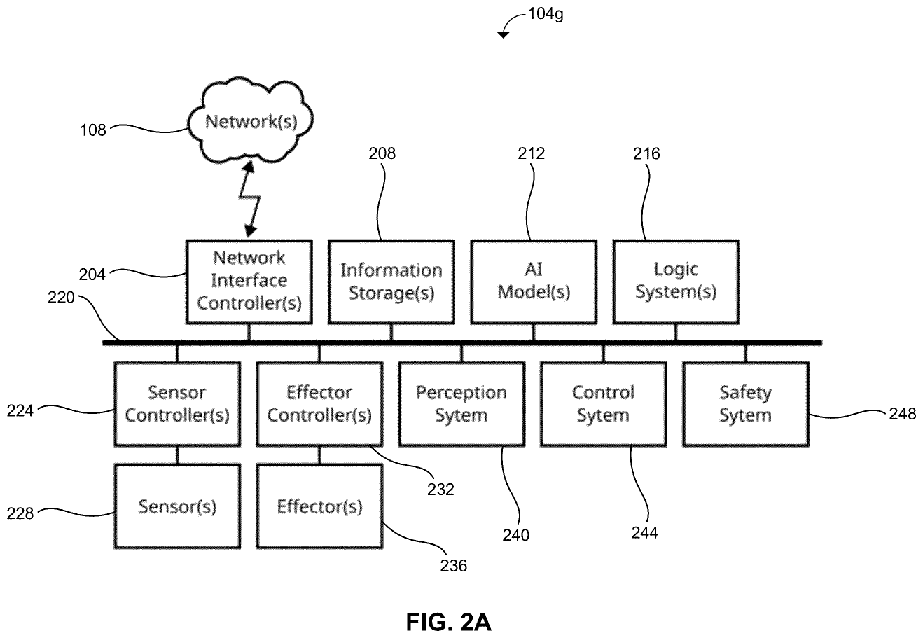

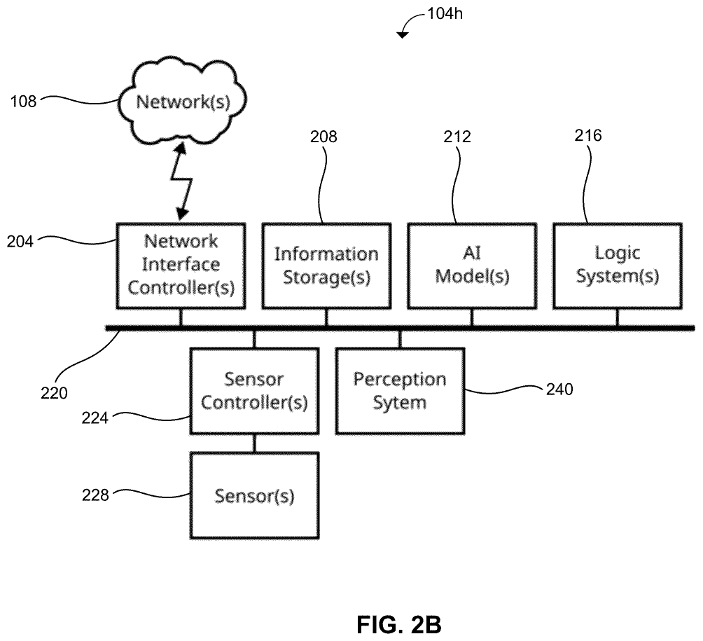

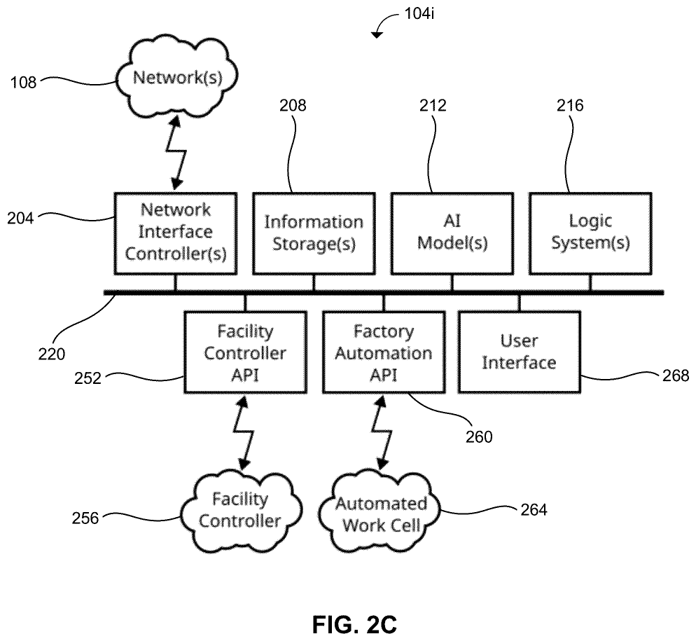

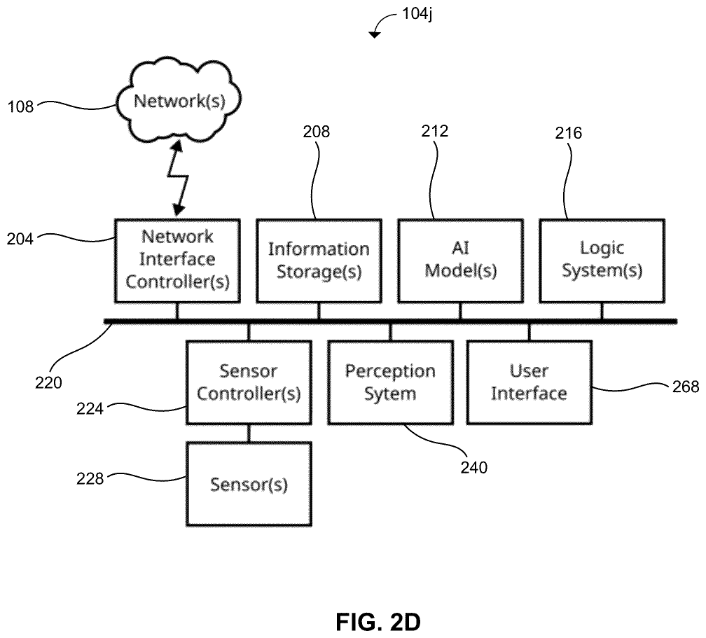

Referring now to FIG. 2A, there is shown a block diagram of an example embodiment of agent 104. In the illustrated embodiment, agent 104g includes one or more network interface controllers 204, one or more information storages 208, one or more AI models 212, one or more logic systems 216, a data bus 220, one or more sensor controllers 224, one or more sensors 228, one or more effector controllers 232, one or more effectors 236, a perception system 240, a control system 244, and a safety system 248. In other embodiments, agent 104 may include any other suitable combination of components. For example, agent 104 may include fewer components (e.g., agent 104 may not include effector controller 232 and effector 236).

Agent 104g may include any suitable number of sensors 228. Sensors 228 may generate sensor data associated with a state and/or an environment of agent 104g. Sensors 228 may include, for example, cameras, light detection and ranging (LiDAR) sensors, microphones, sound navigation and ranging (Sonar) sensors, joint encoders, load cells, pressure sensors, inertial measurement units, temperature sensors, buttons, switches, touch panels, etc. Sensor controllers 224 may control various operations of sensors 228 including, for example, data sensing and data communication.

AI models 212 may include any suitable models that are trained to process input data to generate semantic data output. AI models 212 may include different types of AI models that are suited for performing specific tasks. AI models 212 may include, for example, vision language models (VLMs), audio language models (ALMs), large language models (LLMs), generative AI models, etc. The input data to AI models 212 may include sensor data generated by sensors 228. AI models 212 may generate semantic data based on the applied input sensor data. The generated semantic data may be utilized by agent 104g to control one or more of its operations. In some embodiments, the generated semantic data may be communicated to other agents of the fleet (e.g., via network 108).

Network interface controller 204 can enable agent 104g to communicate (send and/or receive) semantic data with other agents of the fleet using any suitable communication network (e.g., via network 108).

Information storage 208 may store received and/or generated semantic data. For example, the semantic data may be generated by AI models 212. As another example, the semantic data may be received from other agents of the fleet via network 108. The semantic data stored in information storage 208 may be used by logic systems 216, communicated to other agents of the fleet, and/or used as input to AI models 212.

Logic systems 216 may implement any suitable combination of logical rules and/or AI algorithms to determine one or more operations of agent 104g. The input data to logic systems 216 may include received and/or generated semantic data. Logic systems 216 can process the input semantic data to determine operations of agent 104g. The operations of agent 104g may include, for example, operations of perception system 240, control system 244, and/or safety system 248. In some embodiments, logic systems 216 can process semantic data generated at agent 104g to determine whether the semantic data is relevant to other agents of the fleet.

Perception system 240 may include any suitable system that is configured to determine a digital representation of the state of agent 104g and/or the environment of agent 104g. Perception system 240 may utilize sensor data and/or semantic data to determine the digital representation of the state of agent 104g and/or the environment.

Control system 244 may include any suitable system that is configured to control actions of agent 104g. Control system 244 may determine control commands for effectors 236 to perform various actions.

Safety system 248 may include any suitable system that is configured to enable safe operation of agent 104g. Safety system 248 may utilize sensor data to control operation of one or more devices including, for example, brakes, emergency stop, etc.

Agent 104g may include any suitable number of effectors 236. Effectors 236 may include any suitable device configured to affect a state and/or an environment of agent 104g. Effectors 236 may include, for example, actionable joints, lights, speakers, displays, notification systems, etc. Effector controllers 232 may control various operations of effectors 236.

In some embodiments, agent 104g may be a mobile device. For example, agent 104g may be an AMR that captures sensor data while autonomously executing a mission at an industrial facility. The AMR can generate semantic data by applying an AI model (e.g., AI models 212) to the sensor data. The AMR may communicate generated semantic data to other agents of the fleet. In some embodiments, the AMR may receive semantic data generated by other agents of the fleet. The AMR may utilize the generated and/or received semantic data to determine one or more operations while autonomously executing its mission.

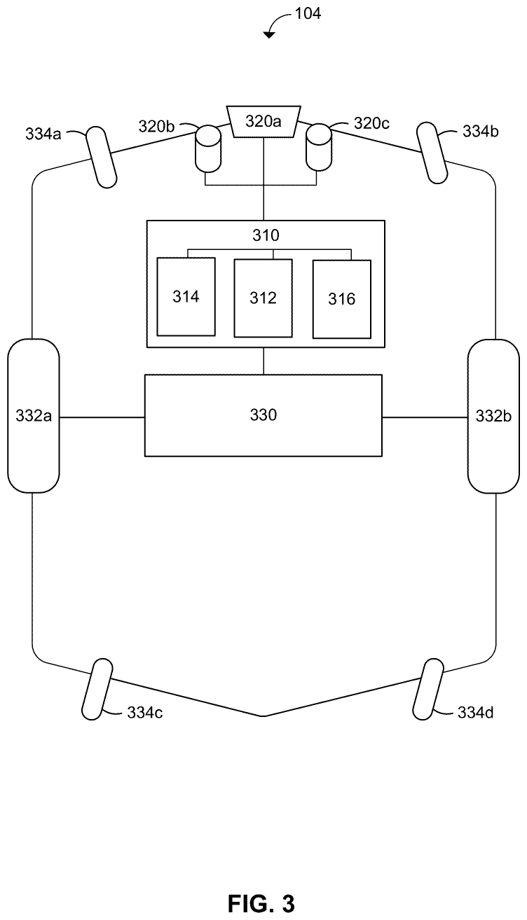

Referring now to FIG. 3, there is shown a schematic diagram illustrating an example embodiment in which agent 104 is a self-driving industrial vehicle. In the illustrated embodiment, self-driving industrial vehicle 104 includes a control system 310, sensors 320a-320c, a drive system 330, drive wheels 332a and 332b, and additional wheels 334a-334d. In other embodiments, self-driving industrial vehicle 104 may include any other suitable combination of components. For example, self-driving industrial vehicle 104 may include fewer components (e.g., self-driving industrial vehicle 104 may not include additional wheels 334a-334d).

Control system 310 may include a processor 312, a memory device 314, and a communication interface 316. Control system 310 can enable self-driving industrial vehicle 104 to operate autonomously. In some embodiments, control system 310 may store an electronic map that represents the environment of self-driving industrial vehicle 104 (e.g., an industrial facility). The electronic map may be stored in memory device 314. Communication interface 316 can be a wireless transceiver for communicating with a wireless communications network (e.g. using an IEEE 802.11 protocol, a 3G/4G protocol or similar).

Sensors 320 may include vehicle sensors (e.g., sensor 320a) and environment sensors (e.g., sensors 320b and 320c).

Environment sensors 320 can enable self-driving industrial vehicle 104 to obtain data about its environment. Environment sensors 320 may include a LiDAR device (or other optical, sonar, or radar-based range-finding devices known in the art). In some embodiments, environment sensors 320 may include optical sensors, such as video cameras and systems (e.g., stereo vision, structured light). In the illustrated example embodiment, environment sensors 320 include optical sensors 320b and 320c that are arranged in a manner to provide three-dimensional (e.g. stereo or RGB-D) imaging. In some embodiments, environment sensors 320 may include humidity sensors for measuring the ambient humidity of the environment, thermal sensors for measuring the ambient temperature of the environment, and/or microphones for detecting sounds in the environment.

Environment sensors 320 are generally in communication with control system 310 so that the control system 310 can receive the measurements from the environment sensors, for example, in order to determine or provide environment state information.

Vehicle sensors 320 may include one or more sensors configured to measure and monitor the state of self-driving industrial vehicle 104 itself, as compared to the environment sensors 320, which sense the vehicle's environment. Vehicle sensors 320 may be associated with particular components of self-driving industrial vehicle 104. For example, vehicle sensors 320 may be current and/or voltage sensors for measuring the current and/or voltage of a particular electrical component, or for determining an approximate state of battery charge. Vehicle sensors 320 may be encoders for measuring the displacement, velocity, and/or acceleration (e.g. angular displacement, angular velocity, angular acceleration) of mechanical components such as motors, wheels, and shafts. Vehicle sensors 320 may be thermal sensors for measuring heat, for example, the heat of a motor or brake. Vehicle sensors 320 may be inertial measurement units for measuring motion of the body of self-driving industrial vehicle 104 (e.g., vehicle sensors 320 may include accelerometers, gyroscopes, magnetometers, etc.). Vehicle sensors 320 may be water ingress sensors for detecting water within the body of self-driving industrial vehicle 104.

In some embodiments, vehicle state information may not be limited to only the information derived from vehicle sensors 320. For example, vehicle state information may also pertain to the mission that self-driving industrial vehicle 104 is executing, the status of the mission, and other operational parameters known to control system 310 independent of input from vehicle sensors 320.

Vehicle sensors 320 are generally in communication with control system 310 so that control system 310 can receive the measurements from the vehicle sensors, for example, in order to determine or provide vehicle state information.

For simplicity and clarity of illustration, the example shown in FIG. 3 shows a single block labelled “320a” for the vehicle sensors and two blocks labelled “320b” and “320c” for the environment sensors, each in communication with control system 310. In some embodiments, there may be any number of environment sensors and/or vehicle sensors, which may or may not all be in communication with control system 310, depending on the nature of the particular environment sensors and vehicle sensors.

In some embodiments, self-driving industrial vehicle 104 may receive a mission from a fleet manager or other external computer system in communication with self-driving industrial vehicle 104 (e.g., in communication via communication interface 316). The mission may contain one or more waypoints or destination locations. Based on the waypoint or destination location contained in the mission, control system 310 can enable self-driving industrial vehicle 104 to autonomously navigate to the waypoint or destination location without receiving any other instructions from an external system. For example, control system 310, along with sensors 320, can enable self-driving industrial vehicle 104 to navigate without any additional navigational aids such as navigational targets, magnetic strips, or paint/tape traces installed in the environment in order to guide self-driving industrial vehicle 104.

For example, control system 310 may plan a path for self-driving industrial vehicle 104 based on a destination location and the location of self-driving industrial vehicle 104. Based on the planned path, control system 310 may control drive system 330 to direct self-driving industrial vehicle 104 along the planned path. As self-driving industrial vehicle 104 is driven along the planned path, environmental sensors 320 may update control system 310 with new images of the environment of self-driving industrial vehicle 104, thereby tracking the progress of self-driving industrial vehicle 104 along the planned path and updating the location of self-driving industrial vehicle 104.

Since control system 310 receives updated images of the environment of self-driving industrial vehicle 104, and since control system 310 is able to autonomously plan self-driving industrial vehicle 104's path and control drive system 330, control system 310 is able to determine when there is an obstacle in the vehicle's path, plan a new path around the obstacle, and then drive self-driving industrial vehicle 104 around the obstacle according to the new path.

Drive system 330 may include a motor and/or brakes connected to drive wheels 332a and 332b for driving self-driving industrial vehicle 104. In some embodiments, the motor may be an electric motor, a combustion engine, or a combination/hybrid thereof. In some embodiments, there may be one motor per drive wheel, for example, one for drive wheel 332a and one for drive wheel 332b. Depending on the particular embodiment, drive system 330 may also include control interfaces that can be used for controlling drive system 330. For example, drive system 330 may be controlled to drive the drive wheel 332a at a different speed than the drive wheel 332b in order to turn self-driving industrial vehicle 104. Different embodiments may use different numbers of drive wheels, such as two, three, four, etc.

In some embodiments, additional wheels 334 may be included (e.g., wheels 334a-334d shown in FIG. 3). Any or all of the additional wheels 334 may be wheels that are capable of allowing self-driving industrial vehicle 104 to turn, such as castors, omni-directional wheels, and mecanum wheels.

The positions of the components 310, 312, 314, 316, 320, 330, 332, and 334 of self-driving industrial vehicle 104 are shown for illustrative purposes and are not limited to the shown positions. Other configurations of the components 310, 312, 314, 316, 320, 330, 332, and 334 are possible.

Referring now to FIG. 2B, there is shown a block diagram of another example embodiment of agent 104. In the illustrated example embodiment, agent 104h includes one or more network interface controllers 204, one or more information storages 208, one or more AI models 212, one or more logic systems 216, a data bus 220, one or more sensor controllers 224, one or more sensors 228, and a perception system 240. Agent 104h may not be mobile and be fixed in position. Agent 104h can generate semantic data associated with a specific location.

In some embodiments, sensors 228 of agent 104h may include one or more cameras mounted at a fixed location in an industrial facility. The fixed location may include, for example, walls, ceilings, racks, doors, hallway entrances, intersections etc. Agent 104h may generate semantic data for locations that have a reduced visibility for mobile agents (e.g., a sharp corner on a robot travel path).

In some embodiments, agent 104h may include interlock devices, for example, mechanical, optical, near field communication, etc. Agent 104h can generate semantic data indicating when and what type of devices are interacting with fleet agents.

In some embodiments, agent 104h may include fixed machinery or smart racks. Agent 104h can generate semantic data indicating one or more operations of fleet agents (e.g., current work being performed by a machine, future scheduled work at a machine, rack storage status, etc.).

Referring now to FIG. 2C, there is shown a block diagram of another example embodiment of agent 104. Agent 104i may include a computational device that provides centralized computing resources to augment or direct other agents of the fleet. In the illustrated example embodiment, agent 104i is a fleet manager and includes one or more network interface controllers 204, one or more information storages 208, one or more AI models 212, one or more logic systems 216, a facility controller application programming interface (API) 252, a facility controller 256, a factory automation API 260, an automated work cell 264, and a user interface 268.

The fleet manager may be configured to perform one or more operations including, for example, tracking other agents in the fleet, sending missions to other agents in the fleet, performing high-level task management, interfacing with external APIs, etc. The fleet manager may generate semantic data, for example, by aggregating semantic data received from other agents of the fleet. The fleet manager may enable communication of semantic data between agents of the fleet, for example, between agents that cannot communicate directly with each other. In some embodiments, the fleet manager may utilize semantic data to perform one or more of its operations.

In some embodiments, agent 104i may include a facility management system and/or an inventory management system that is configured to track various machines, mechanisms, and inventory in an industrial facility. In some embodiments, agent 104i may include a networked computational device (e.g., a cloud server) that can execute AI models that are computationally intensive and not suitable for edge devices.

Referring now to FIG. 2D, there is shown a block diagram of another example embodiment of agent 104. In the illustrated example embodiment, agent 104j includes one or more network interface controllers 204, one or more information storages 208, one or more AI models 212, one or more logic systems 216, one or more sensor controllers 224, one or more sensors 228, a perception system 240, and a user interface 268.

Agent 104j may be a non-autonomous device. For example, agent 104j may be a human-operated work truck that includes instrumentation to enable communication with other agents of the fleet. Agent 104j may generate semantic data while performing one or more operations. Agent 104j may generate the semantic data based on sensor data from sensors 228 and/or user input received from a human operator. Agent 104j may communicate the generated semantic data to other agents of the fleet and/or the human operator. For example, agent 104j may communicate semantic data generated based on user task requests to other agents of the fleet. As another example, agent 104j may receive semantic data from other agents of the fleet and communicate information related to events/situations that are otherwise unknown (e.g., not visible/audible) to the human operator.

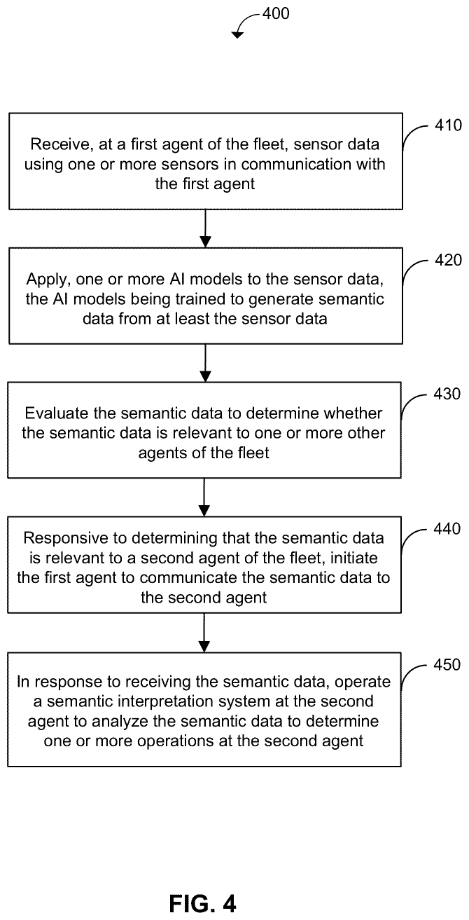

Referring to FIG. 4, there is a flow diagram 400 of an example method for facilitating communication of semantic data between a fleet of agents. The fleet of agents may include, for example, the fleet of agents shown in FIG. 1 and concurrent reference is made herein below to components shown in FIGS. 1 to 3. Agents 104 may include one or more autonomous mobile robots (e.g., agents 104 illustrated in FIGS. 2A and 3).

At 410, a first agent of the fleet may receive sensor data using one or more sensors in communication with the first agent. For example, agent 104g (FIG. 2A) may receive sensor data from sensors 228. The sensor data may include any suitable data including, for example, image data, audio data, and/or text data.

At 420, the first agent may apply one or more AI models to the sensor data. The AI models can be trained to generate the semantic data for the fleet of agents from at least the sensor data. The AI models may include, for example, AI models 212 of agent 104.

Agent 104 may be initialized with a set of basic actions that the agent understands, objects and/or events that the agent recognizes, and/or data parameters that augment these actions, objects, and/or events. After initialization, agent 104 may monitor the state and/or environment of the agent using sensor data from sensors 228. Agent 104 may apply AI models 212 to the sensor data to generate the semantic data. The semantic data in this context can include the actions, objects, events, data parameters, and/or their associations.

For example, the received sensor data may include audio data for a verbal command from a user—“Where is robot 57?”. Agent 104 can generate semantic data by applying an ALM to the received sensor data. The generated semantic data can indicate a query action for the position of an object, a first data parameter specifying the object type as an AMR, and a second data parameter specifying the serial number “57”).

As another example, agent 104 may apply an ALM to received audio sensor data to generate semantic data indicating specific actions, objects and/or events including, for example, honking action, skidding tire event, collision event, hissing gas leak events, etc.

As another example, agent 104 may apply a VLM to received camera sensor data to generate corresponding semantic data indicating specific objects (e.g., pallets, AMRs, forklifts, boxes, containers, labels, etc.) and associated information. The generated semantic data can indicate, for example, a pallet type object, a first data parameter specifying the pallet's size and position, and a second data parameter specifying the pallet's color. In some embodiments, the VLM may be trained for detecting text in the received camera data. For example, the generated semantic data for a camera image of an inventory label may include a data parameter specifying the inventory ID number.

In some embodiments, the generated semantic data may indicate object properties (e.g., the chair is blue), object actions (e.g., a forklift is raising/lowering its lift, a pallet has fallen on its side), and/or object relationships (e.g., the chair next to the door).

System 100 can facilitate user interaction with the fleet of agents by generating semantic data based on user inputs. In some embodiments, the semantic data may include data generated using natural language processing of a user input. For example, sensors 228 of agent 104 may include a microphone that receives verbal commands/queries from a user. The sensor data from the microphone may be input to AI models 212. The AI models 212 can generate semantic data using natural language processing of the received user commands/queries. In some embodiments, sensors 228 of agent 104 may include a camera. The sensor data from the camera may capture visual signals provided by a user. The sensor data from the camera may be input to AI models 212. The AI models 212 can generate semantic data based at least in part on the visual signals.

In some embodiments, AI models 212 may be trained to map the sensor data to a multi-dimensional vector space to compress data size of the generated semantic data compared with the sensor data. For example, the multi-dimensional vector space may be defined to encode object type, object ID and/or other object properties associated with an object detected in a captured image. The generated semantic data for the object can thereby have a smaller data size compared with the captured image of the object.

In some embodiments, agent 104 may augment the sensor data with other data. The other data may include previously generated and/or received semantic data. For example, agent 104 may combine generated semantic data with previously received semantic data to generate new and useful semantic data.

At 430, the first agent may evaluate the semantic data to determine whether the semantic data is relevant to one or more other agents of the fleet. For example, agent 104 may utilize the semantic data generated at 420 to determine one or more of its own operations. Further, agent 104 may evaluate the generated semantic data to determine whether the semantic data is relevant to any other agent of the fleet.

In some embodiments, agent 104 may apply logic systems 216 to the generated semantic data to evaluate the relevance of the semantic data. Logic systems 216 may implement any suitable combination of logical rules and/or AI algorithms to evaluate the relevance of the semantic data. Logic systems 216 may evaluate the relevance of the generated semantic data by determining whether the semantic data is new when compared with stored semantic data and whether the semantic data is usable in performing an operation at another agent.

For example, logic systems 216 may compare the generated semantic data with stored semantic data to determine if the generated semantic data is new. The stored semantic data may include semantic data previously generated by agent 104 and/or semantic data previously received from other agents of the fleet.

As another example, the generated semantic data may indicate an orientation of an object that a given robot agent is ready to pick up. Logic systems 216 may determine that this semantic data is useful for the given robot agent but is not useful to other agents of the fleet. Logic systems 216 may therefore evaluate that the generated semantic data is not relevant to any other agent of the fleet.

As another example, the generated semantic data at a given robot agent may indicate the presence of an obstacle along a shared robot travel path in an industrial facility. Logic systems 216 may determine that this semantic data is useful in navigation operations of the given robot agent. Further, logic systems 216 may determine that this semantic data is also useful to other agents of the fleet (e.g., other mobile robots that may plan a travel route that is blocked by the obstacle, a fleet manager configured to assign missions to a robot capable of removing the obstacle, etc.). Logic systems 216 may therefore evaluate that the generated semantic data is relevant to one or more other agents of the fleet.

In some embodiments, logic systems 216 may determine that the generated semantic data is useful to one or more specific other agents of the fleet. For example, the generated semantic data may indicate a velocity restriction for a specific zone of an industrial facility. Agent 104 may determine that the generated semantic data is useful to other mobile agents and a fleet manager, but is not useful to agents that are fixed camera devices.

At 440, responsive to determining that the semantic data is relevant to a second agent of the fleet, the first agent may communicate the semantic data to the second agent. For example, agent 104b (FIG. 1) may determine that the semantic data generated at 430 is relevant to agent 104c (FIG. 1). In response, agent 104b may communicate the semantic data to agent 104c. Agent 104b may communicate the semantic data directly to agent 104c.

In some embodiments, there may not be a direct communication link between agents 104b and 104c. Agent 104b may communicate the semantic data to fleet manager 104d and fleet manager 104d may subsequently communicate the semantic data to agent 104c.

In some embodiments, the two agents may belong to different fleets. The communication between the two agents may occur via one or more intermediaries. For example, a first agent may communicate generated semantic data to a first fleet manager. The first fleet manager may communicate the semantic data to a second fleet manager of a different fleet. The second fleet manager may further communicate the semantic data to one or more agents of its fleet.

In some embodiments, an agent may aggregate semantic data received from multiple agents. For example, a fleet manager may aggregate semantic data received from two or more agents of the fleet. The fleet manager may aggregate the semantic data based on location and/or timing information associated with the semantic data.

For example, the fleet manager may receive semantic data from a first agent indicating a first location of an object at a first time. Further, the fleet manager may receive semantic data from a second agent indicating a second location of the object at a second time. The fleet manager may aggregate the semantic data to generate new semantic data indicating that the object has moved from the first location to the second location during the time interval between the second time and the first time.

At 450, in response to receiving the semantic data, a semantic interpretation system may be operated at the second agent to analyze the semantic data to determine one or more operations at the second agent. In some embodiments, logic systems 216 may include the semantic interpretation systems. In other embodiments, semantic interpretation systems may be implemented independent of logic systems 216.

The semantic interpretation system may implement any suitable combination of logical rules and/or AI algorithms to analyze the received semantic data. The semantic interpretation system may be operated to determine one or more operations of perception system 240, control system 244 and/or safety system 248 at the second agent based at least in part on the semantic data received from the first agent. In some embodiments, the semantic data received from the first agent may be combined with semantic data generated at the second agent to determine the one or more operations.

The second agent may start, stop, or alter an operation based at least in part on the received semantic data. For example, the received semantic data may indicate traffic congestion along a planned travel route of the second agent. In response, the second agent may change its planned route (i.e., change an operation) and/or send a notification alerting a user that the second agent will be delayed in completing its mission (i.e., perform a new operation).

System 100 can facilitate user interaction with the fleet of agents by generating semantic data based on user inputs at any given agent. The semantic data generated at a first agent (at 420) may be utilized to determine operations at the first agent. Further, the semantic data may be communicated to a second agent (at 440). The received semantic data may be utilized to determine operations at the second agent (at 450).

For example, a user may provide a verbal command at a first agent to modify fleet behavior—“Drive slowly near the cafeteria for the next hour”. At 410, a first agent can receive sensor data for the user command from a microphone. At 420, the first agent can apply one or more AI models to the sensor data to generate semantic data based at least in part on the sensor data. The semantic data may indicate, for example, a velocity restriction for a one-hour time period for a location/area associated with the cafeteria. Based at least in part on the generated semantic data, the first agent may modify its own operations to comply with the velocity restriction. At 430, the first agent may evaluate that the semantic data is relevant to a fleet manager and other mobile agents of the fleet. At 440, the first agent may communicate the semantic data to the fleet manager and other mobile agents of the fleet. At 450, another mobile agent (e.g., a second agent) may modify its operations based at least in part on the semantic data received from the first agent. For example, the second agent may modify its operations to comply with the velocity restriction.

In some embodiments, system 100 can facilitate user interaction with the fleet of agents by generating user outputs at any given agent based on semantic data. The semantic data utilized for generating the user output may have been generated at that given agent and/or may have been received from other agents of the fleet.

For example, effectors 236 of agent 104 may include audio effectors (e.g., speakers). Agent 104 may apply a suitable AI model 212 (e.g., an LLM) and a suitable text to speech (TTS) technology to generate user audio output based on semantic data. In some embodiments, TTS technology may not be used to generate the user audio output. For example, the user audio output may include a pre-recorded message. In some embodiments, the user audio output may not include speech. For example, the user audio output may include audible notes and/or tones. The audible notes and/or tones may be used to convey any suitable messages including, for example, user alerts and/or warnings.

As another example, effectors 236 of agent 104 may include visual effectors (e.g., display screens). Agent 104 may apply a suitable AI model 212 (e.g., an LLM) to the semantic data to generate a user output display. The user output display may include a displayed text message based at least in part on the semantic data. In some embodiments, the user output display may not include a displayed text message. For example, the user output display may include visual indicators and/or signals, The visual indicators and/or signals may include, for example, warning/danger indicators, turn signals, a map display, etc.

System 100 can provide an improvement in functionality of the fleet of agents by facilitating communication of semantic data generated at one agent to be communicated to other agents. The received semantic data can enable the other agents to analyze actions, objects, events, and/or data parameters that the other agents may not have direct access to (e.g., because sensors associated with the other agents are unable to directly sense the corresponding actions, objects, events, and/or data parameters). The received semantic data can improve the understanding of the environment of the other agents. Further, the other agents can determine one or more of their operations based on the improved understanding of the environment (i.e., based at least in part on the received semantic data).

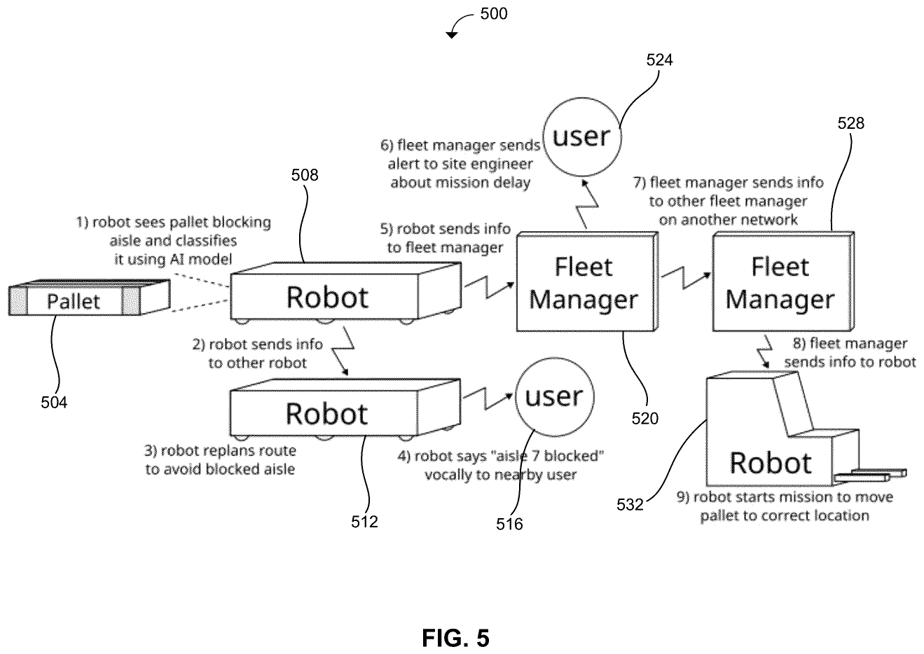

Referring now to FIG. 5, there is shown a schematic diagram 500 illustrating an exemplary implementation of the method of FIG. 4 and concurrent reference is made to flow diagram 400. Schematic diagram 500 illustrates an example of improved functionality provided by the disclosed systems and methods.

At 410, a first agent (robot) 508 may receive sensor data (e.g., from a camera, LiDAR, sonar) indicating that an object 504 is blocking a travel aisle.

At 420, robot 508 may apply an AI model (e.g., a VLM) to detect the object 504 and identify the type of object 504 (a pallet). Robot 508 can generate semantic data indicating that a pallet is blocking the travel aisle, and that the pallet is unlikely to move in the immediate future.

At 430 and 440, robot 508 may combine the generated semantic data with geolocation and temporal data and communicate the combined data to other agents of the fleet.

At 450, other agents of the fleet may determine one or more operations based at least in part on the semantic data received from first agent 508.

Agent (robot) 512 may have planned a travel route that included the blocked travel aisle. Based at least in part on the received semantic data, robot 512 may change its planned route to avoid the blocked travel aisle. Further, robot 512 may generate an audio user output to notify nearby users about the blocked travel aisle.

Based at least in part on the received semantic data, a fleet manager 520 may send notifications/alerts to users (e.g., user 524). Fleet manager 520 may send the notifications/alerts, for example, using audio outputs, indicator lights/panels, digital messages, etc. Further, fleet manager 520 may communicate the received semantic data to a fleet manager 528 of a different fleet.

Based at least in part on the received semantic data, fleet manager 528 may communicate with an agent (robot) 532 that is capable of moving the pallet to clear the travel aisle. Further, robot 532 can determine one or more operations to move the pallet and clear the travel aisle.

As illustrated by the above example, system 100 can provide an improvement in functionality of the fleet of agents by facilitating communication of semantic data generated at agent 508 to other agents. In the illustrated example, the other agents did not have direct access to sensor data indicating that pallet 504 is blocking a travel aisle. However, system 100 can facilitate the communication of semantic data generated by agent 508 to other agents. In response, the other agents can determine one or more operations based at least in part on the received semantic data.

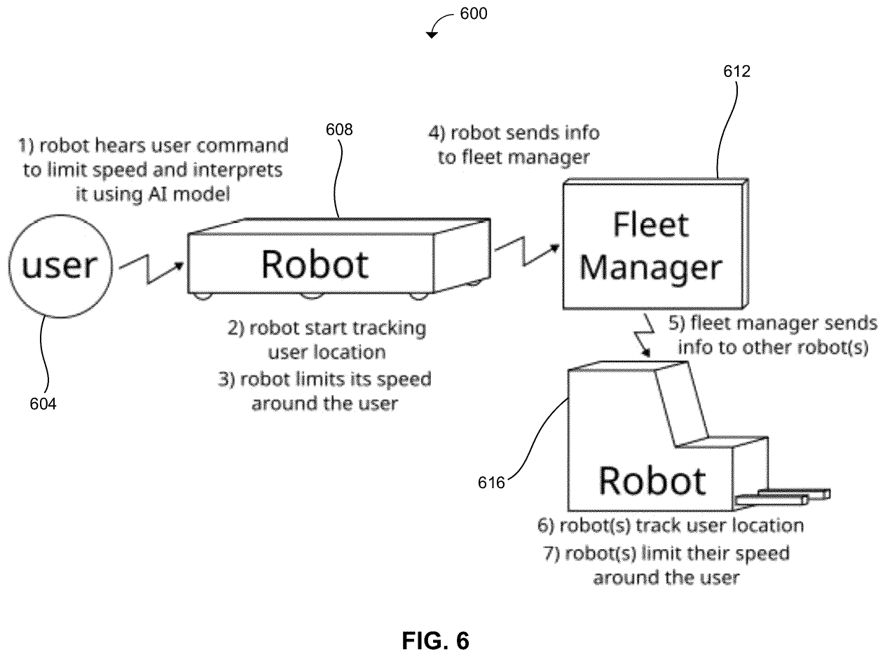

Referring now to FIG. 6, there is shown a schematic diagram 600 illustrating an exemplary implementation of the method of FIG. 4 and concurrent reference is made to flow diagram 400. Schematic diagram 600 illustrates another example of improved functionality provided by the disclosed systems and methods.

At 410, a first agent (robot) 608 may receive sensor data (e.g., from a microphone) indicating a verbal command to limit speed when in proximity to a user 604.

At 420, robot 608 may apply an AI model (e.g., an ALM) to process the received sensor data. Robot 608 can generate semantic data indicating a velocity restriction zone. Further, robot 608 can apply a facial recognition AI model to image sensor data that captures user 604's face. Robot 608 can generate semantic data indicating an identity of user 604. Robot 608 can combine the generated semantic data indicating the velocity restriction zone and the identity of user 604 to generate new semantic data. The new semantic data can specify a velocity restriction zone that is centered around the specific user 604. Based on the new semantic data, robot 608 can limit its speed around user 604.

At 430 and 440, robot 608 may determine that the new semantic data is relevant to other agents of the fleet. Robot 608 may communicate the new semantic data to other agents of the fleet including, for example, a fleet manager 612 and a robot 616.

At 450, other agents of the fleet may determine one or more operations based at least in part on the semantic data received from robot 608. For example, other agents of the fleet may begin tracking a location of user 604. The tracked location of user 604 may be utilized to define the velocity restriction zone around user 604. Mobile agents of the fleet (e.g., robot 616) may use their control systems to limit velocity around user 604 according to the velocity restriction zone. In some embodiments, after the velocity restriction zone has been implemented for a certain time period, a fleet agent may query user 604 (e.g., using effectors like display screens or speakers) whether the velocity restriction zone can be ended or whether it should be maintained.

As illustrated by the above example, system 100 can provide an improvement in functionality of the fleet of agents by facilitating communication of semantic data generated at agent 608 to other agents. In the illustrated example, the other agents did not have direct access to sensor data indicating the verbal command provided by user 604. However, system 100 can facilitate the communication of semantic data generated by agent 608 to other agents. In response, the other agents can comply with the velocity restriction zone around user 604.

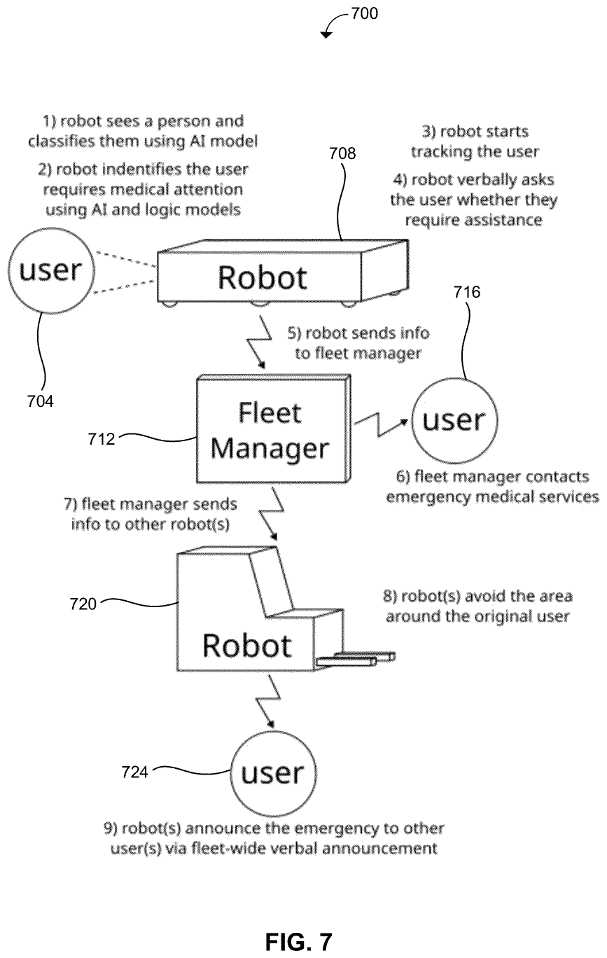

Referring now to FIG. 7, there is shown a schematic diagram 700 illustrating an exemplary implementation of the method of FIG. 4 and concurrent reference is made to flow diagram 400. Schematic diagram 700 illustrates another example of improved functionality provided by the disclosed systems and methods.

At 410, a first agent (robot) 708 may receive sensor data (e.g., from a camera, LiDAR, sonar) indicating an object 704 in the environment.

At 420, robot 708 may apply an AI model (e.g., a VLM) to detect the object 704 and identify the type of object 704 (a user/human). Robot 708 can determine the identity of user 704 by applying a facial recognition AI model to image sensor data that captures user 704's face. Robot 708 can generate a first piece of semantic data indicating identity of imaged user 704. Robot 708 may apply a second AI model to identify the behavior being exhibited by user 704. For example, user 704 may be lying unmoving on the ground. Robot 708 may use a logic system to determine that a human lying unmoving on the ground represents a medical emergency. Robot 708 can generate a second piece of semantic data indicating a medical emergency associated with user 704. Robot 708 can combine the generated semantic data with temporal and location information associated with imaged user 704. Further, robot 708 can combine all the received and derived information to generate semantic data indicating that user 704 at the specified location is having a medical emergency and the associated timing of the emergency.

Based on the generated semantic data, robot 708 may determine one or more of its own operations. For example, robot 708 may start tracking movements (if any) of user 704. As another example, robot 708 may query whether user 704 requires assistance (e.g., using effectors like speakers).

At 430 and 440, robot 708 may communicate the generated semantic data to other agents of the fleet (e.g., fleet manager 712, robot 720).

At 450, other agents of the fleet may determine one or more operations based at least in part on the semantic data received from robot 708. For example, fleet manager 712 may contact emergency medical services (e.g., user 716). Further, fleet manager 712 may communicate the received semantic data to other agents of the fleet. In response to the received semantic data, robot 720 may change planned travel routes to avoid an area around user 704 to reduce congestion in the area. Further, robot 720 may generate user outputs (e.g., using display screens, speakers) to alert other users (e.g., user 724) regarding the medical emergency associated with user 704.

As illustrated by the above example, system 100 can provide an improvement in functionality of the fleet of agents by facilitating communication of semantic data generated at agent 708 to other agents. In the illustrated example, the other agents did not have direct access to sensor data indicating the medical emergency associated with user 704. However, system 100 can facilitate the communication of semantic data generated by agent 708 to other agents. In response, the other agents can determine one or more operations based at least in part on the received semantic data.

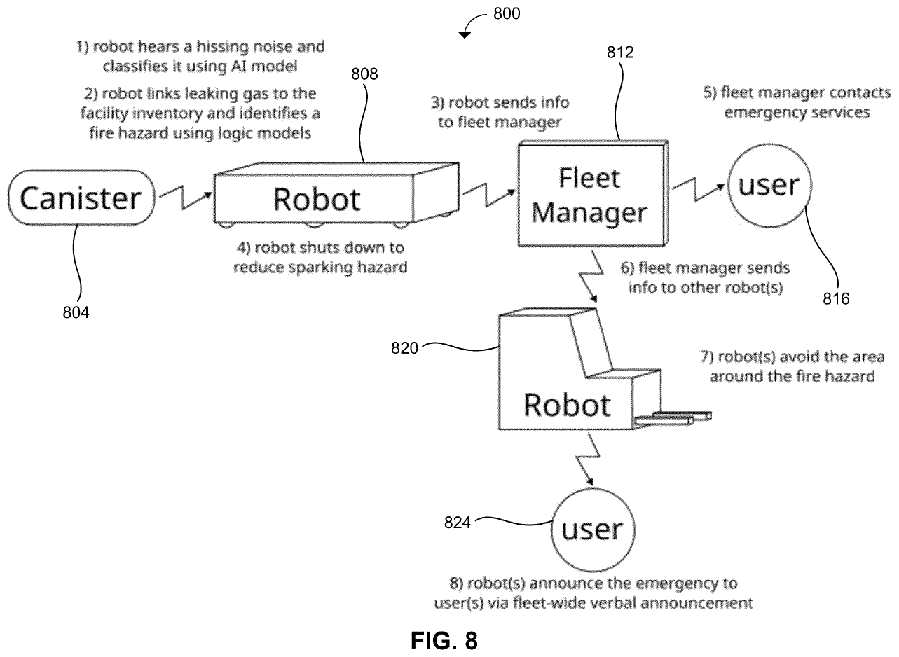

Referring now to FIG. 8, there is shown a schematic diagram 800 illustrating an exemplary implementation of the method of FIG. 4 and concurrent reference is made to flow diagram 400. Schematic diagram 800 illustrates another example of improved functionality provided by the disclosed systems and methods.

At 410, a first agent (robot) 808 may receive sensor data (e.g., from a microphone) indicating a hissing sound in the environment.

At 420, robot 808 may apply an AI model (e.g., an ALM) to detect that the hissing sound is associated with a gas leak. Robot 808 may use a logic system to combine the sound type information with geolocation data and facility inventory data to generate semantic data indicating that the gas leak is associated with canister 804 and represents a fire hazard.

At 430 and 440, robot 808 may communicate the generated semantic data to other agents of the fleet (e.g., fleet manager 812). Further, based on the generated semantic data, robot 808 may determine one or more of its own operations. For example, robot 808 may shut down to reduce a sparking hazard.

At 450, other agents of the fleet may determine one or more operations based at least in part on the semantic data received from robot 708. For example, fleet manager 812 may contact emergency medical services (e.g., user 816). Further, fleet manager 812 may communicate the semantic data to other agents of the fleet (e.g., robot 820).

Robot 820 may determine one or more of its operations based at least in part on the received semantic data. For example, robot 820 may update planned travel routes to avoid the fire hazard area associated with canister 804. As another example, robot 820 may generate user outputs (e.g., using display screens, speakers) to alert other users (e.g., user 824) regarding the fire hazard. Robot 820 may use any suitable AI model (e.g., generative AI models) to generate text, audio and/or visual messages to alert users. Other fleet agents (not shown in FIG. 8) that are located in proximity to the fire hazard may utilize the received semantic data to respond appropriately. For example, a mobile agent may determine if its current position blocks any emergency routes. After confirming (or moving to) a safe position, the mobile agent may shut down to reduce sparking and fire hazards.

As illustrated by the above example, system 100 can provide an improvement in functionality of the fleet of agents by facilitating communication of semantic data generated at agent 808 to other agents. In the illustrated example, the other agents did not have direct access to audio sensor data indicating the gas leak and fire hazard associated with canister 804. However, system 100 can facilitate the communication of semantic data generated by agent 808 to other agents. In response, the other agents can determine one or more operations based at least in part on the received semantic data.

As another example, at 410, a first agent (robot) may receive sensor data (e.g., from a camera and/or a microphone) indicating an operation state of machinery or equipment in an industrial facility.

At 420, the first agent may apply an AI model (e.g., a VLM and/or an ALM) to the sensor data. The AI model may be trained to generate an output indicating an issue (e.g., a degraded performance, an imminent failure) with the machinery/equipment associated with the sensor data. For example, the sensor data may capture a rattling sound or an image of an oil leak indicating a malfunctioning component of the associated machinery/equipment. The first agent may use a logic system to combine the AI output with facility and/or location data to generate semantic data indicating the detected issue and the associated machinery/equipment.

At 430 and 440, the first agent may communicate the generated semantic data to other agents of the fleet, for example, a user device. At 450, other agents of the fleet may determine one or more operations based at least in part on the semantic data received from the first agent. For example, the user device may provide a notification (e.g., visual indicator, audio signal, text message) to an operator indicating that the associated machinery/equipment needs repair and/or preventative maintenance.

System 100 can provide an improvement in fleet intelligence by facilitating communication of semantic data between the fleet of agents. In some embodiments, fleet agents can continuously communicate their state (e.g., position, velocity, capabilities, current actions, etc.), the state of any observed objects, and observed events to all other agents in the fleet. The shared data may include associated timing and location data. Such fleet communication can enable the fleet to generate and maintain a shared understanding of the environment that the fleet is operating within. Each agent may store generated and received semantic data locally. The agent may apply any suitable AI models and/or logic systems to the stored semantic data to maintain an understanding of its state and environment.

The shared semantic data and the resulting understanding of the environment can be utilized by agents for logical decision-making. For example, a mobile agent planning a route can utilize shared information related to route congestion/blockages to select the best available route for completing a mission. As another example, the fleet of agents can track objects in the environment through repeated observation by various fleet agents (e.g., tracking where a particular inventory item is located).

In some embodiments, a shared fleet understanding of historical events can enable fleet agents to leverage existing data to predict future events. Any suitable combination of AI models and/or logic systems may be implemented to predict a future event based on historical event data. For example, historical event data indicating observed forklift traffic in a specific travel aisle around noon each day may be utilized to generate semantic data indicating that the specific travel aisle is a high-traffic region around noon each day. Fleet agents may utilize the shared semantic data to determine one or more operations. For example, mobile fleet agents may avoid travel through the specific travel aisle during the high-traffic times (around noon each day).

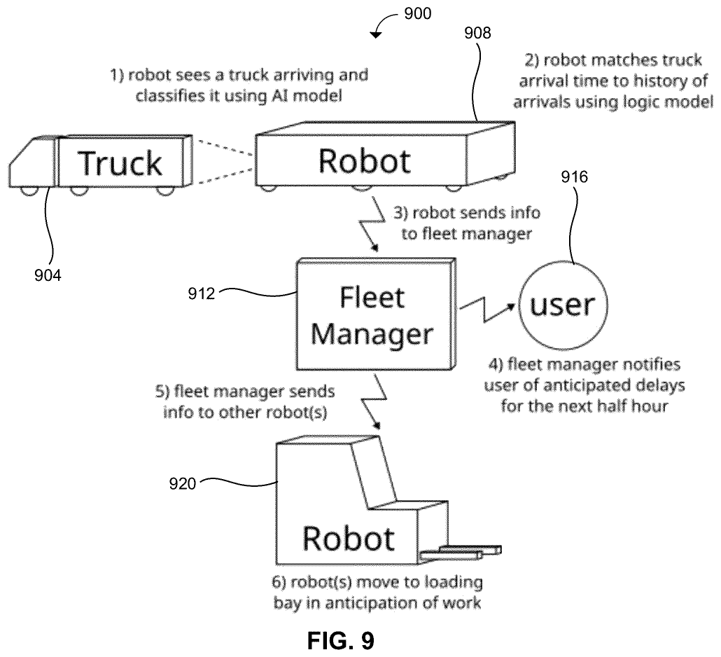

Referring now to FIG. 9, there is shown a schematic diagram 900 illustrating an exemplary implementation of the method of FIG. 4 and concurrent reference is made to flow diagram 400. Schematic diagram 900 illustrates an example of improved fleet intelligence provided by the disclosed systems and methods.

At 410, a first agent (robot) 908 may receive sensor data (e.g., from a camera, LiDAR, sonar) indicating that an object 904.

At 420, robot 908 may apply an AI model (e.g., a VLM) to the received sensor data to generate semantic data indicating that the object is a delivery truck 904 and an associated event that the delivery truck 904 is docking to a loading bay. Robot 908 may further augment the generated semantic data using geolocation data associated with truck 904 and/or the loading bay.

At 430 and 440, robot 908 may communicate the generated semantic data to other agents of the fleet (e.g., fleet manager 912).

At 450, fleet manager 912 may use any suitable combination of AI models and/or logic systems to compare the detected event to semantically similar historical events. Based on the comparison, fleet manager 912 may predict a future event (e.g., a truck unloading event, a transport robot pickup event of items unloaded from the truck, a traffic congestion event near the loading bay during the unloading and pickup, etc.). In some embodiments, robot 908 may predict the future events and communicate to fleet manager 912.

Fleet manager 912 may determine one or more operations and/or communicate the predicted future events to other agents of the fleet. For example, fleet manager 912 may communicate the predicted event and/or assign a mission to robot 920 to move to the loading bay in anticipation of the pickup event. Robot 920 may utilize the received predicted event information and/or the assigned mission to move to the loading bay in anticipation of the pickup event. As another example, fleet manager 912 may communicate the predicted event and/or instruct other mobile agents (not shown in FIG. 9) to update their travel routes to avoid predicted traffic congestion near the loading bay. The mobile agents may utilize the received predicted event information and/or the updated routing instructions to avoid the predicted traffic congestion. As another example, fleet manager 912 may notify a user 916 of a predicted mission delay based on the predicted traffic congestion near the loading bay.

As illustrated by the above example, system 100 can provide an improvement in fleet intelligence by facilitating communication of semantic data between the fleet of agents.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

As used herein, the term “media” generally means “one medium or more than one medium”.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, a wireless device or any other computing device capable of being configured to carry out the methods described herein.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

1. A method for operating a fleet of agents within an industrial facility based at least on a plurality of semantic data generated from input data collected during operation of the fleet of agents comprising one or more autonomous mobile robots, each autonomous mobile robot having a processor, the method comprising:
receiving, at a first agent of the fleet, an input dataset comprising sensor data collected with one or more sensors in communication with the first agent;
evaluating the input dataset to identify one or more critical features, the one or more critical features comprising one or more features being prioritized according to a context of the input dataset;
identifying, based at least on a data type of the one or more critical features and the context of the input dataset, an initial artificial intelligence (AI) data model suitable for interpreting the one or more critical features;
applying the initial artificial intelligence data model to at least a subset of the input dataset to generate a semantic dataset from the one or more critical features for the fleet of agents, the semantic dataset providing contextual guidance of an environment of the first agent;
evaluating the semantic dataset to determine whether further evaluation is required to improve an operation of the fleet of agents;
in response to determining that further evaluation of the semantic dataset is required:
evaluating the semantic dataset to identify, based at least on a context of the semantic dataset, a subsequent artificial intelligence data model suitable for refining the semantic dataset for improving the operation of the fleet of agents; and
applying the subsequent artificial intelligence model to the semantic dataset to further refine the semantic dataset to improve the operation of the fleet of agents;
otherwise, evaluating the semantic dataset to identify one or more other agents within the fleet for which the one or more critical features identified from the input dataset is relevant;
responsive to determining that the semantic dataset is relevant to the one or more other agents, initiating, by the first agent, communication of the semantic dataset to the one or more agents, the semantic dataset having a semantic data size smaller than an input data size of the input dataset, whereby improving a transmission efficiency from the first agent; and
in response to receiving the semantic dataset at the one or more agents, operating a semantic interpretation system at the one or more other agents to analyze the semantic dataset to determine one or more operations at each other agent of the one or more other agents, the one or more operations comprising at least one different operation as between e ach other agent of the one or more other agents.

2. The method of claim 1, wherein evaluating the semantic dataset to determine whether the semantic dataset is relevant comprises:
determining that the generated semantic dataset is new compared with stored semantic dataset; and
determining that the generated semantic dataset is usable in performing an operation at the one or more other agents.

3. The method of claim 1, wherein the initial and subsequent artificial intelligence data models are trained to map the sensor data to a multi-dimensional vector space to compress data size of the generated semantic dataset compared with the sensor data.

4. The method of claim 1, wherein the initial and subsequent artificial intelligence data models include one or more of a large language model, a vision language model and an audio language model.

5. The method of claim 1, wherein the semantic dataset comprises data generated using natural language processing of a user input.

6. The method of claim 1, wherein the first agent is an autonomous mobile robot that receives the sensor data while autonomously executing a mission at the industrial facility.

7. The method of claim 1, wherein the generated semantic dataset is communicated by the first agent to at least one other agent via a fleet manager.

8. The method of claim 7, wherein the fleet manager aggregates the semantic dataset received from multiple agents.

9. The method of claim 8, wherein the fleet manager aggregates the semantic dataset based on location and/or timing information associated with the semantic dataset.

10. The method of claim 1, wherein the semantic interpretation system at the one or more other agents is operated to determine one or more operations of a perception system, a control system and/or a safety system of the one or more other agents based at least in part on the semantic dataset received from the first agent.

11. A system for operating a fleet of agents within an industrial facility based at least on a plurality of semantic data generated from input data collected during operation of the fleet of agents comprising one or more autonomous mobile robots, the system comprising:
a communication network; and
the fleet of agents comprising the one or more autonomous mobile robots, the fleet of agents operable to communicate with each other via the communication network, each agent of the fleet having a processor, wherein the processors are collectively operable to:
receive, at a first agent of the fleet, an input dataset comprising sensor data collected with one or more sensors in communication with the first agent;
evaluate the input dataset to identify one or more critical features, the one or more critical features comprising one or more features being prioritized according to a context of the input dataset;
identify, based at least on a data type of the one or more critical features and the context of the input dataset, an initial artificial intelligence (AI) data model suitable for interpreting the one or more critical features;
apply the initial artificial intelligence data model to at least a subset of the input dataset to generate a semantic dataset from the one or more critical features for the fleet of agents, the semantic dataset providing contextual guidance of an environment of the first agent;
evaluate the semantic dataset to determine whether further evaluation is required to improve an operation of the fleet of agents;
in response to determining that further evaluation of the semantic dataset is required:
evaluate the semantic dataset to identify, based at least on a context of the semantic dataset, a subsequent artificial intelligence data model suitable for refining the semantic dataset for improving the operation of the fleet of agents, and
apply the subsequent artificial intelligence models to the semantic dataset to further refine the semantic dataset to improve the operation of the fleet of agents;
otherwise, evaluate the dataset to identify one or more other agents within the fleet for which the one or more critical features identified from the input dataset is relevant;
responsive to determining that the semantic dataset is relevant to the one or more other agents, initiate, by the first agent, communication of the semantic dataset to the one or more agents, the semantic dataset having a semantic data size smaller than an input data size of the input dataset, whereby improving a transmission efficiency from the first agent; and
in response to receiving the semantic dataset at the one or more agents, operate a semantic interpretation system at the one or more other agents to analyze the semantic dataset to determine one or more operations at each other agent of the one or more other agents, the one or more operations comprising at least one different operation as between each other agent of the one or more other agents.

12. The system of claim 11, wherein evaluation of the semantic dataset to determine whether the semantic dataset is relevant comprises:
determining that the generated semantic dataset is new compared with stored semantic dataset; and
determining that the generated semantic dataset is usable in performing an operation at the one or more other agents.

13. The system of claim 11, wherein the initial and subsequent artificial intelligence data models are trained to map the sensor data to a multi-dimensional vector space to compress data size of the generated semantic dataset compared with the sensor data.

14. The system of claim 11, wherein the initial and subsequent artificial intelligence data models include one or more of a large language model, a vision language model and an audio language model.

15. The system of claim 11, wherein the semantic dataset comprises data generated using natural language processing of a user input.

16. The system of claim 11, wherein the first agent is an autonomous mobile robot that receives the sensor data while autonomously executing a mission at the industrial facility.

17. The system of claim 11, wherein the generated semantic dataset is communicated by the first agent to at least one other agent via a fleet manager.

18. The system of claim 17, wherein the fleet manager aggregates semantic dataset received from multiple agents.

19. The system of claim 18, wherein the fleet manager aggregates the semantic dataset based on location and/or timing information associated with the semantic dataset.

20. The system of claim 11, wherein the semantic interpretation system at the one or more other agents is operated to determine one or more operations of a perception system, a control system and/or a safety system of the one or more other agents based at least in part on the semantic dataset received from the first agent.
